(19) United States
(12) Patent Application Publication
(10) Pub. No.: US 2005/0035614 A1
(43) Pub. Date: Feb. 17, 2005

(54) Light bulb puller

(76) Inventor: Ralph Wessel, Cayucos, CA (US)

Correspondence Address: RALPH WESSEL, 3166 SHEARER AVE, CAYUCOS, CA, 93430, US

(21) Appl. No.: 10/638,203

(22) Filed: Aug. 11, 2003

(51) Int. Cl. B25B 9/02

(52) U.S. Cl. 294/99.2

(57) ABSTRACT

This is a tool to aid in the changing of small bulbs such as Christmas tree light bulbs. These bulbs are pressure fitted and there is no easy way to pull them from their sockets for repair or replacement. The present embodiments provide a specially designed tool to remove pressure fitted light bulbs from their base. The tool is uniquely shaped to fit into a users hand and allows for easy removing and changing of pressure fitted bulbs. In some preferred embodiments, the tool includes a notch that is beveled or chamfered to fit between the bulb shoulder and the base. Some embodiments have a generally “U” shape, while other embodiments may have circular, oblong, rectangular or other shapes. Further, some embodiments include a 90 degree bend near the notches.

### BACKGROUND

References Cited

| | | | |
|---|---|---|---|
| 6561673 | May 13, 2003 | Fredrick | 439/501 |
| 6167602 | Jan. 2, 1961 | Yang et al. | 29/278 |
| 6047464 | Mar. 11, 2000 | Chadbourne et al. | 29/274 |
| 5316512 | May 31, 1994 | Ell | 445/61; 29/764 |

This invention was developed to fill a need to have a small tool that is easy to use when removing or replacing small Christmas tree type lamp bulbs.

The Christmas tree bulbs are small (overall size approximately. 1″) with a plastic bottom that fits tightly into a plastic receptacle or base. The plastic bottom of the lamp has a shoulder on top. This bottom fits into a base connected to the electric cord.

The difficulty occurs when it becomes necessary to replace them with a different bulb. To insure good electrical contact it is necessary that the two plastic surfaces fit together very tightly. With the small size and tight fit it becomes difficult to release the lamp from its' base. We have tried pliers, side cutters and fingernails to pry the lamp from its' base. The side cutters were the best but were too clumsy. Using one's fingernail often results in broken nails. So we put the advantage of side cutters into a small easy to use tool. This would be especially helpful for those who have difficulty due to arthritis or age. This tool was designed to do this job easily and at little manufacturing cost.

The tool may be made out of metal or plastic.

### BRIEF SUMMARY OF INVENTION

The tool consists of a simple “U” shaped unit with the top of the “U” bent inward and notched to allow it to grasp the plastic bottom of a small light bulb and extract it from its base. It could be made from metal or plastic.

### DESCRIPTION OF THE DRAWING

FIG. 1—top view

FIG. 2—end view

FIG. 3—side view

FIG. 4—sketch of a hand with the tool in use.

FIG. 5—sketch of typical small bulb

### DETAILED DESCRIPTION

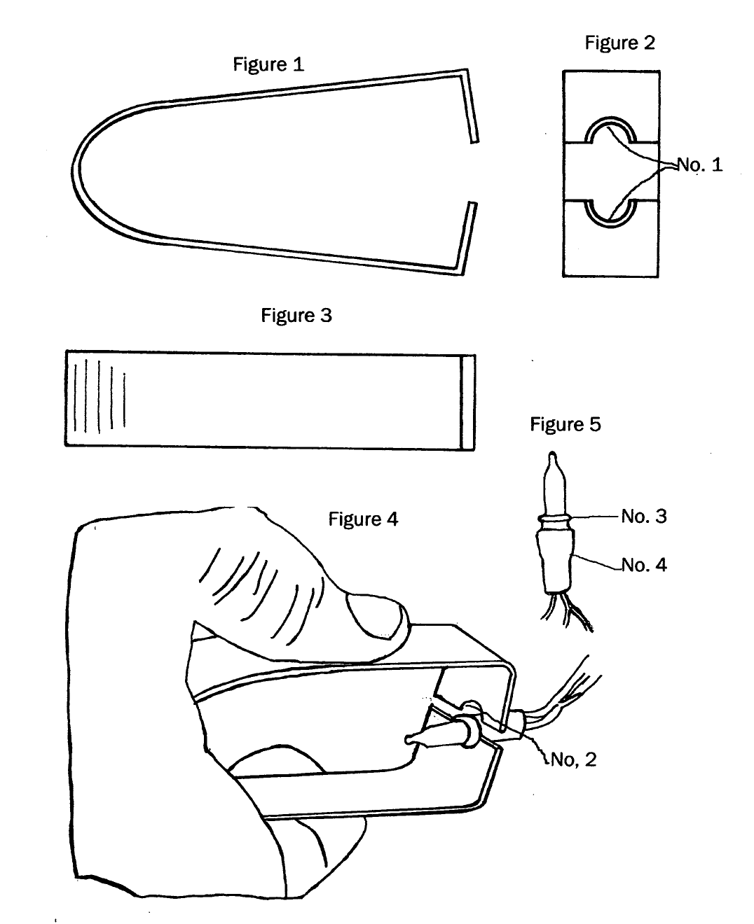

The tool consists of a flat piece of metal or a synthetic material, formed into a “U” shape with the open end of the U bent inward at 90 degrees to the side as in FIG. 1. When pressure is placed on the outside of the “U” the two ends come together. Each of the ends has a notch, as in FIG. 2, just large enough to fit around the lamp sockets in FIG. 4, No. 2.

The notch can be beveled to fit in the location where the lamp bottom's shoulder FIG. 5, No. 3 meets the base FIG. 5, No. 4.

Side pressure on the tool compresses the tool and clamps onto the lamp base. A slight outward pull releases the lamp from its base. Releasing the side pressure on the tool allows the lamp to be released. A very simple and effective movement.

The tool should be made with just enough stiffness or spring to return to its' original shape when pressed as shown in FIG. 4 but still be easy to compress.

1-3. (cancelled).

4: A tool for use in removing a pressure fitted light bulb from a base, the tool comprising:
a flat piece having a first end and a second end;
the flat piece is shaped such that the first end generally facing each other;
a first notch formed in the first end wherein the first notch is beveled; and
a second notch formed in the second end wherein the second notch is beveled.

5: The tool of claim 4, wherein the flat piece comprises a first bend proximate the first end such that the first end is bent toward the second end; and
the flat piece comprises a second bend proximate the second end such that the second end is bent toward the first end.

6: The tool of claim 5, wherein the flat piece comprises a third bend such that the flat piece has a generally “U” shape.

7: The tool of claim 5, wherein the first bend is a bend of about 90 degrees, and the second bend is a bend of about 90 degrees.

8: The tool of claim 4, wherein the flat piece further comprises a first side extends away from the second bend, and a second side extends away from the third bend, wherein the second and third bends are configured such that the first end and the second end are substantially aligned when a force is applied to both the first and second sides.

9: A tool for use in removing a pressure fitted light bulb from a base, the tool comprising:
a flat piece having a first end and a second end, where the flat piece is shaped such that the first end is proximate the second end;
the flat piece comprises a first bend proximate the first end such that the first end is bent toward the second end;
the flat piece comprises a second bend proximate the second end such that the second end is bent toward the first end;
a first notch formed in the first end wherein the first notch is chamfered; and
a second notch formed in the second end wherein the second notch is chamfered.

10: The tool of claim 9, wherein the flat piece comprises a third bend such that the flat piece has a generally “U” shape.

11: The tool of claim 9, wherein the flat piece is shaped to have generally a circular shape.

12: The tool of claim 9, wherein the flat piece is shaped to have generally an oblong shape.

13: A tool for use in removing a pressure fitted light bulb from a base, the tool comprising:
a flat piece having a first end and a second end;
the flat piece is shaped with a generally circular shape such that the first end generally faces the second end;
a first notch formed in the first end wherein the first notch is beveled; and
a second notch formed in the second end wherein the second notch is beveled.
